(19) United States
(12) Patent Application Publication
(10) Pub. No.: US 2005/0263989 A1
(43) Pub. Date: Dec. 1, 2005

(54) Gas bag module

(75) Inventor: Matthias Helmstetter, Aschaffenburg (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive Safety Systems GmbH

(21) Appl. No.: 11/136,846

(22) Filed: May 25, 2005

(30) Foreign Application Priority Data
Jun. 1, 2004 (DE) 20 2004 008 624.7

(51) Int. Cl. B60R 21/20

(52) U.S. Cl. 280/728.3

(57) ABSTRACT

A gas bag module has a housing, which comprises a cover part, at least one side wall that is joined to the cover part, and a base section that is joined to the side wall. The housing opens along a plurality of predetermined separation lines when the gas bag module is activated, to allow the emergence of a gas bag. The separation lines run across the cover part, the side wall and/or and the base section such that, after activation of the gas bag module, the housing becomes separated into parts along the separation lines into a plurality of segments that are not directly connected to each other. Each segment includes a section of the cover part, the side wall and the base section.

### FIELD OF THE INVENTION

The present invention relates to a gas bag module.

### BACKGROUND OF THE INVENTION

The gas bag module is normally closed towards a vehicle interior by a covering cap, formed for instance by a cover part of a housing. It is known to provide zones of weakness in a covering cap of a gas bag module, e.g., in the form of predetermined breaking points, or tear lines, so that when the gas bag module is activated an exit opening will be created for the gas bag. Sections of the covering cap separate and swivel along the zones of weakness, allowing the gas bag to emerge from the housing. It is important that a sufficiently large exit opening be exposed in the shortest possible time in order not to hinder the deployment of the gas bag. The resulting sections of the covering cap, or the housing, can be used to exert a controlled influence on the deployment of the gas bag.

It is an object of the present invention to provide a gas bag module that satisfies these points in a simple manner.

### BRIEF SUMMARY OF THE INVENTION

This object is achieved by a gas bag module having a housing, which comprises a cover part, at least one side wall that is joined to the cover part, and a base section that is joined to the side wall. The housing opens along a plurality of predetermined separation lines when the gas bag module is activated, to allow the emergence of a gas bag. The separation lines run across the cover part, the side wall and/or and the base section such that, after activation of the gas bag module, the housing becomes separated into parts along the separation lines into a plurality of segments that are not directly connected to each other. Each segment includes a section of the cover part, the side wall and the base section.

In this manner, a large exit opening can be created very rapidly. According to the present invention, the housing segments no longer cohere after the housing has been opened along the separation lines. At most an indirect connection remains via other attachment elements, e.g., via the connection of the gas bag module to a vehicle-fixed part as an instrument panel or a steering wheel, so that the segments cannot escape loose into the interior of the vehicle. The housing segments can also remain connected to each other and to the vehicle, e.g., via a gas generator or a gas bag support element. The cover part forms the portion of the housing that will be visible in the vehicle and serves here as a covering cap.

The resulting individual segments can move independently of each other, thus making it possible to influence the deployment of the gas bag in a controlled manner.

The separation lines are formed by weakened zones, which can be configured in a well-known, conventional manner, e.g., as tear lines.

Preferably, a hinged joint, e.g., a film hinge, is provided in an area in which the side wall continues into the base section, the hinge making it possible for the side wall to move relative to the base section. In this way the side wall can swivel away completely to the outside, thus enlargening the exit opening. The hinge is preferably arranged as far away as possible from the cover part, e.g., at the level of a gas generator mounting.

The base section is preferably made up of a plurality of flaps, which are pivotally fixed to a lower end of the side wall. Therefore, it is unnecessary to provide separation lines in the area of the base section as well, because the base section is already made up of a plurality of separate segments.

In one preferred embodiment of the present invention, the separation lines run radially outwards on the cover part and across the side wall to a lower end of the side wall. In the case of a round or rectangular gas bag module, it is possible to provide, e.g., three or four separation lines, which run across the cover part radially and then parallel to an axis of the housing across an, e.g., wrap-around-type side wall, down to its lower end. In this case, when the gas bag module is activated, the housing separates into segments that resemble pieces of pie.

It is advantageous if, prior to activation of the gas bag module, the housing is configured in one piece, it being possible to manufacture it, e.g., integrally in an injection molding process using a suitable plastic material.

The gas bag module according to the present invention can use both annular gas bags, during whose deployment a central part of the gas bag is retained on the gas bag module, as well as conventional gas bags, in which the central part also moves into the vehicle interior. When an annular gas bag is used, the separation lines preferably begin on the exterior periphery of a central part of the cover part, the central part being retained on the gas bag module when the gas bag is deployed.

### BRIEF DESCRIPTION OF THE DRAWINGS

FIG. 1 depicts a schematic perspective representation of a gas bag module according to the present invention in a first view; and

FIG. 2 depicts a schematic perspective view of a gas bag module according to the present invention in a second view.

### DETAILED DESCRIPTION OF A PREFERRED EMBODIMENT

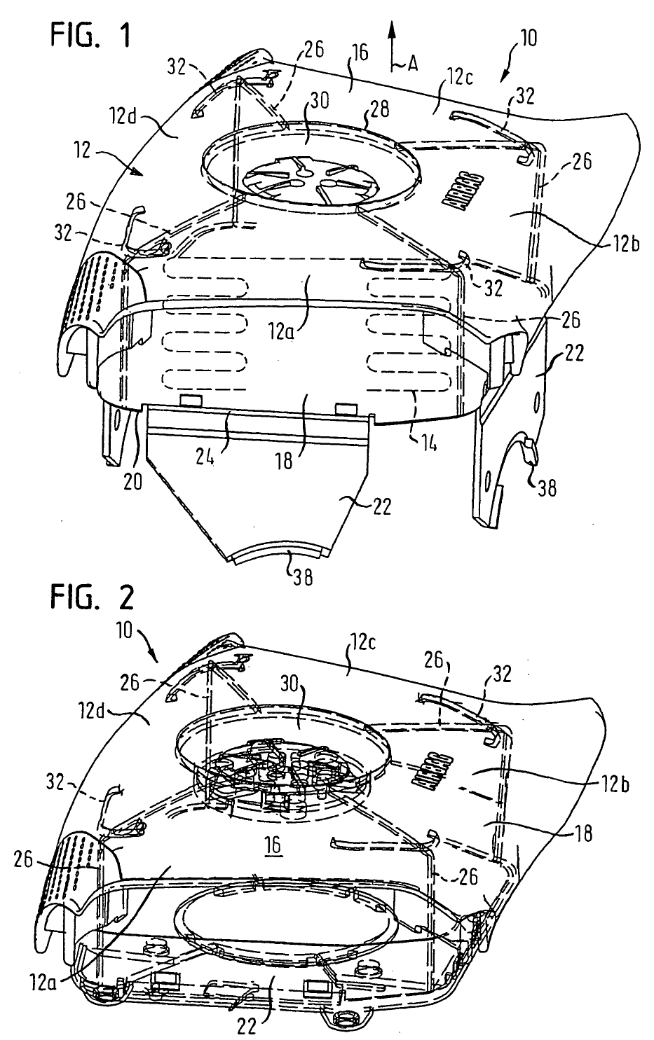

FIG. 1 shows a gas bag module 10, having an essentially four-cornered housing 12 and a folded gas bag 14 accommodated in the housing 12 that is only sketched in FIG. 1. In the housing 12 further a gas generator (not depicted here) is accommodated, which, when the gas bag module 10 is activated, supplies the pressurized gas that is necessary for deploying the gas bag 14.

The housing 12 has a plurality of sections, which at first are all joined to each other in an integral fashion. A cover part 16 forms the upper side of the gas bag module 10 and, in the installed state, closes off the gas bag module from an interior of the vehicle, acting as a covering cap. A surrounding side wall 18 having four essentially straight sections is joined to the cover part 16, perpendicular to it. Molded at the lower end 20 of the side wall 18 opposite the cover part 16 are four flaps 22, one at each portion of the side wall 18 and each connected by a film hinge 24, the flaps 22 together constituting a base section of housing 12.

In the housing 12 four weakened zones are provided, e.g., tear lines or predetermined breaking points, which form separation lines 26, along which the housing 12 opens when the gas bag module 10 is activated. The separation lines 26 all run radially outwards from an annular tear line 28, which surrounds a central part 30, remaining fixed when the housing 12 is opened, of the cover part 16, and across the cover part 16, in this case each to a respective corner of the housing 12. From there each separation line 26 without interruption runs parallel to an axis A (FIG. 1) of the housing 12 across the side wall 18 down to the lower end 20 thereof. The housing 12 is therefore subdivided into four individual segments 12a-12d.

In each corner of the cover part 16, an additional weakened zone 32 is provided, which aids the opening of the housing 12. The additional weakened zones 32 also permit an independent swiveling motion of the cover part section of each segment 12a-12d in relation to the side wall section of the respective segment 12a-12d.

In assembling the gas bag module 10, in the state indicated in FIG. 1 with flaps 22 opened, the folded gas bag 14 as well as the gas generator (not depicted here) are inserted into the interior of housing 12. A central section of the gas bag 14 is attached to the gas generator and to the fixed central part 30 of the cover part 16. Then all flaps 22 are swiveled radially to the inside. The flaps 22 are shaped so that, in this state, their radial inner edges 38 contact a flange of the gas generator. The flaps 22, the gas generator, and the gas bag 14 are joined to each other in a well-known manner, employing well-known attachment means, possibly using a gas bag support element. In this way, the gas bag module 10 constitutes a self-contained, closed unit, even before it is installed in the vehicle. This state is depicted in FIG. 2. For mounting in a vehicle, the gas bag module 10 has only to be fixed to the vehicle using well-known attachment means.

The gas bag module 10 can be configured as a so-called floating horn module, i.e., it can be attached within a steering wheel so that, for activating a horn, it can be moved in its entirety into the steering wheel.

When gas bag module 10 is activated and the gas generator is ignited, the housing 12, due to the increased interior pressure, opens along the separation lines 26. In the process, the housing 12 separates into four separate segments 12a-12d that do not cohere to each other. Because each separation line 26 comes to an end between two flaps 22 and runs to the lower end 20 of the side wall 18, the housing 12 can completely separate into the four segments 12a-12d.

Each segment 12a-12d includes a section of the cover part 16 and of the side wall 18, and one flap 22 of the base section.

The four segments 12a-12d remain connected to each other via the attachment of the flaps 22 to the vehicle, or the gas generator, so that no loose parts can escape into the vehicle interior. Nevertheless, there is no longer any direct connection between the segments 12a-12d. Therefore, the housing 12 can swing open far to the side and create a large exit opening for the gas bag 14. Because the side wall 18 in each segment 12a-12d is connected to one of the flaps 22 by a hinge 24, the sections of the side wall 18 and of the cover part 16 of each segment 12a-12d can swing away outwards after the separation of the housing, which enlargens the exit opening.

The housing 12, or its installation space in a vehicle, can be configured so that individual segments 12a-12d, or the sections of side wall 18 that are each assigned to the individual segments 12a-12b, are swiveled to a preestablished position in which they can influence the deployment of the gas bag 14 in a preestablished manner.

Instead of using an annular gas bag, as shown here, the gas bag module could also contain a conventional gas bag, whose central part deploys into the vehicle interior. In this case, the separation lines could begin together in a central point of the cover part.

1. A gas bag module,
having a housing (12), which comprises a cover part (16), at least one side wall (18) that is joined to the cover part (16), and a base section that is joined to the side wall,
the housing (12) having a plurality of predetermined separation lines (26), along which the housing (12) opens when the gas bag module (10) is activated, to allow the emergence of a gas bag (14),
wherein the separation lines (26) run across at least one of the cover part (16), the side wall (18) and the base section such that, after activation of the gas bag module, the housing (12) becomes separated into parts along the separation lines (26) into a plurality of segments (12a-d) that are not directly connected to each other, each segment (12a-d) including a section of the cover part (16), the side wall (18), and the base section.

2. The gas bag module as recited in claim 1, wherein in an area in which the side wall (18) continues into the base section via a hinge (24) making it possible for the side wall (18) to move relative to the base section.

3. The gas bag module as recited in claim 2, wherein the base section is made up of a plurality of flaps (22), which are pivotally fixed to a lower end (20) of the side wall (18).

4. The gas bag module as recited in claim 1, wherein the separation lines (26) run radially outwards on the cover part (16) and across the side wall (18) to a lower end (20) of the side wall (18).

5. The gas bag module as recited in claim 1, wherein the housing (12), prior to activation of the gas bag module (10), is configured in one piece.

6. The gas bag module as recited in claim 1, wherein the gas bag (14) is accommodated folded in the housing (12).
